(19) United States
(12) Patent Application Publication
(10) Pub. No.: US 2009/0152031 A1
(43) Pub. Date: Jun. 18, 2009

(54) Outlet duct of battery system for hybrid electric vehicle

(75) Inventor: Hae Kyu Lim, Gyeonggi-do (KR)

Correspondence Address: Edwards Angell Palmer & Dodge LLP, P.O. Box 55874, Boston, MA, 02205, US

(73) Assignees: Hyundai Motor Company, Seoul (KR); Kia Motors Corporation, Seoul (KR)

(21) Appl. No.: 12/151,067

(22) Filed: May 2, 2008

(30) Foreign Application Priority Data
Dec. 13, 2007 (KR) 10-2007-0129591

(51) Int. Cl. B60K 11/06

(52) U.S. Cl. 180/68.1; 903/903

(57) ABSTRACT

The present invention provides an outlet duct for discharging air to the outside during air cooling in a battery system for a hybrid electric vehicle.

The outlet duct of a battery system for a hybrid electric vehicle in accordance with the present invention has a new structure in which the outlet duct, through which air is discharged after air-cooling of the battery system (or high voltage parts), does not extend to an extractor grill; instead, an inlet hole is formed at a front end of a rear filler assembly and an outlet hole is formed at a rear end thereof. With the structure, cooling performance can be improved. Moreover, it is possible to prevent water or dust from being introduced from the bottom of the vehicle due to the shape of the side member. Furthermore, it is possible to simplify the shape of the outlet duct, thereby improving productivity. In addition, it is possible to reduce the pressure resistance against the air flow in advance, thereby improving cooling performance.

### CROSS-REFERENCE TO RELATED APPLICATION

This application claims under 35 U.S.C. §119(a) the benefit of Korean Patent Application No. 10-2007-0129591 filed Dec. 13, 2007, the entire contents of which are incorporated herein by reference.

### BACKGROUND

(a) Technical Field

The present invention relates to an outlet duct of a battery system for a hybrid electric vehicle. More particularly, the present invention relates to an outlet duct for discharging air to the outside during air cooling in a battery system for a hybrid electric vehicle.

(b) Background Art

Intensive researches have been made to develop a vehicle which can cope with the global warming, resource exhaustion, and urban air pollution and further realize the high-efficiency and low emission.

One approach is to develop a hybrid electric vehicle (HEV) which can improve fuel efficiency. In general, the HEV has two power sources, an internal combustion engine and an electric motor, and effectively uses them for saving energy and lowering emission.

Most of the HEVs developed so far are broadly classified into a series type and a parallel type based on the power transmission structure. Both types use a battery which acts as a buffer for supplying electric power or charging the same when the engine driving force is insufficient or excessive.

Since a large number of batteries are used in the HEV, the process of cooling the batteries becomes one of the most important problems to be solved.

Especially, in case of the series type HEV, since the driving force of the engine is all converted into electricity, stored in the batteries, and used to operate a drive motor, there is a difficulty in that the capacity and size of the battery should be increased.

Moreover, since a plurality of batteries are connected in series in the series type HEV to generate electric power of more than about 300 V, the average temperature of the whole batteries and the temperature variation should be within a predetermined range that does not affect the performance in order to maintain the performance and durability.

In general, the battery system of the HEV forcibly intakes indoor air using a blower driven by a motor, injects the air to the batteries to be cooled, and then discharges the air to the outside of the vehicle.

In the HEV, the air after cooling the batteries is discharged to the outside through an outlet duct. Such an outlet duct has a complicated structure extending to an extractor grill provided at the rear portion of the trunk.

However, such a structure has drawbacks in that the length of the outlet duct cannot be shortened, the number of processes for fixing the extended duct to a vehicle body portion is increased, and the availability of the trunk space is decreased.

Moreover, the complicated structure of the outlet duct may cause resistance against air flow, in which the cooling efficiency may be significantly deteriorated.

Also, the number of parts of the outlet duct is increased, thereby increasing the manufacturing cost.

Furthermore, since the extractor grill is mounted at the final discharge stage of the outlet duct, the pressure may be increased to lower the cooling performance, and noise may be generated due to a collision between blocking rubber and cooling air in the discharge region.

The information disclosed in this Background section is only for enhancement of understanding of the background of the invention and should not be taken as an acknowledgement or any form of suggestion that this information forms the prior art that is already known to a person skilled in the art.

### SUMMARY OF THE DISCLOSURE

The present invention has been made in an effort to solve the above-described problems associated with prior art. The present invention is directed to an outlet duct of a battery system for a hybrid electric vehicle, the outlet duct having a new structure in which the outlet duct, through which air is discharged after air-cooling of the battery system (or high voltage parts), does not extend to an extractor grill; instead, an inlet hole is formed at a front end of a rear filler assembly and an outlet hole is formed at a rear end thereof, thus improving the cooling performance. Moreover, it is possible to prevent water or dust from being introduced from the bottom of the vehicle due to the shape of the side member. Furthermore, it is possible to simplify the shape of the outlet duct, thereby increasing productivity. In addition, it is possible to reduce the pressure resistance against the air flow in advance, thereby improving the cooling performance.

In one aspect, the present invention provides an outlet duct of a battery system for a hybrid electric vehicle, the battery system including an inlet duct for the inflow of indoor air, a blower, and an outlet duct for discharging air after cooling process, wherein the outlet duct is connected to a side member of a rear filler assembly provided with at least one inlet hole, through which air is introduced from the outlet duct, formed at a front end thereof and at least one outlet hole, through which air is discharged to an outside, formed at a rear end thereof, and the inner space of the side member is used as a flow path of air.

With the structure, air can flow in the order: the inlet duct→battery system→outlet duct→side member inlet hole→side member flow path→side member outlet hole→outside.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a perspective view showing an outlet duct of a battery system for a hybrid electric vehicle in accordance with a preferred embodiment of the present invention;

FIG. 2 is an enlarged view of an A portion in FIG. 1;

FIG. 3 is a cross-sectional view taken along line B-B of FIG. 2; and

FIG. 4 is a side view showing the outlet duct of a battery system for a hybrid electric vehicle in accordance with the preferred embodiment of the present invention.

Reference numerals set forth in the Drawings includes reference to the following elements as further discussed below:

| | |
|---|---|
| 10: inlet duct | 11: blower |
| 12: outlet duct | 13: side member |
| 14: inlet hole | 15: flow path |
| 16: outlet hole | 17: battery system |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

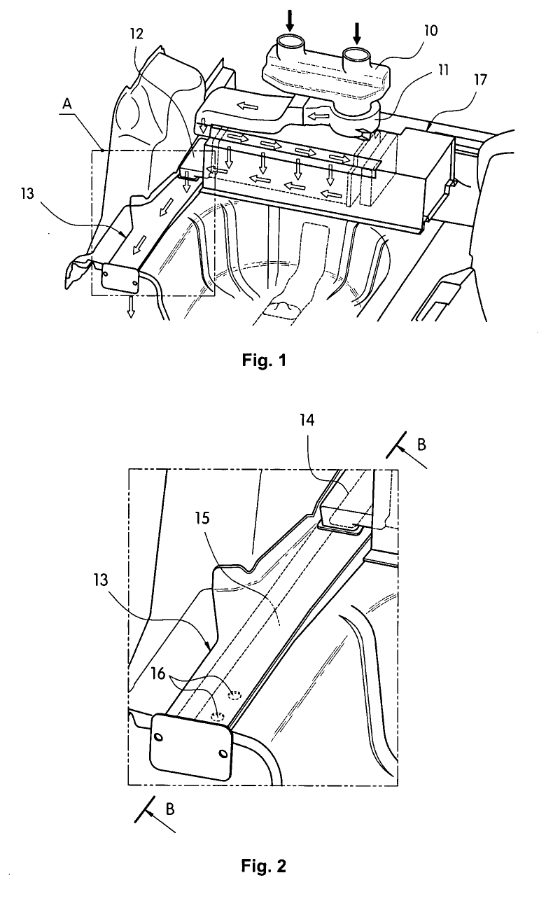

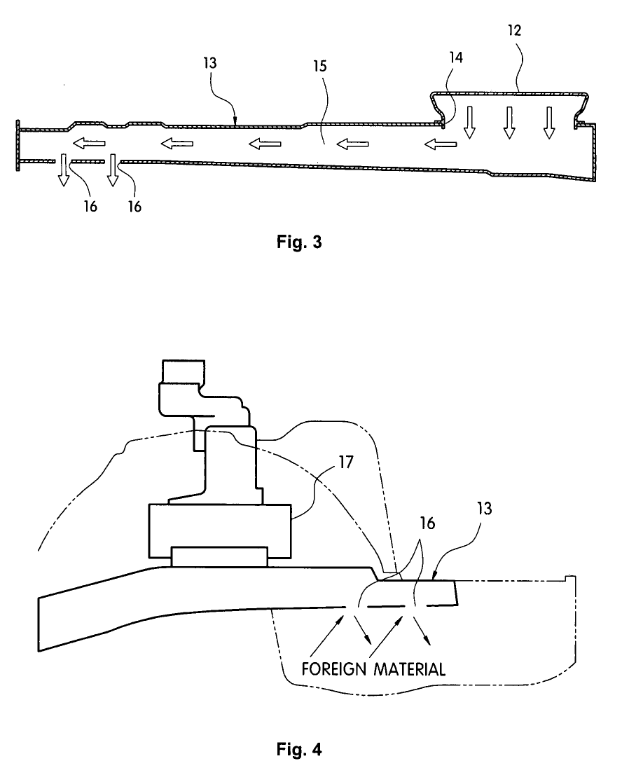

As shown in FIGS. 1 to 4, an outlet duct 12 for discharging air exhausted from a battery system 17 of an HEV to the outside has a structure in which a side member 13 of a rear filler assembly disposed on one side of the battery system 17 is utilized as it is. Accordingly, the length of the discharge path of air can be greatly reduced, compared with the conventional discharge path extending to the rear portion of the trunk, and thus it is possible to reduce the overall length of the outlet duct 12, thus effectively discharging the air.

For this, the battery system 17, in which an inlet duct 10 for the inflow of indoor air and a blower 11 for forcibly intaking air are provided on a top portion thereof, and an outlet duct 12 for discharging air after cooling process is provided on a bottom portion thereof, is included in the trunk in the vehicle.

At least one inlet hole 14 is formed at a front end of one side member 13, disposed in the longitudinal direction of the vehicle and coming in contact with the outlet duct 12, among the side members 13 of the rear filler assembly positioned on both sides of the battery system 17.

Preferably, the inlet hole 14 may be formed with a structure in which an upper plate of the side member 13 having a rectangular cross section is punched.

The thus formed inlet hole 14 is connected to the outlet duct 12 of the battery system 17 such that the air discharged through the outlet duct 12 may be introduced to the inside of the side member 13 through the inlet hole 14.

The side member 13 is a vehicle body structure having a rectangular cross section and its inner space in the form of a rectangular cross section may be used as a flow path 15.

Accordingly, with the structure of the side member 13 arranged in the longitudinal direction of the vehicle, the air discharged from the battery system 17 can flow in the longitudinal direction of the vehicle toward the rear.

Moreover, at least one or two outlet holes 16 are formed on the bottom surface at the rear end of the side member 13, and thus the air flowing in the side member 13 can be discharged downwardly through the outlet holes 16.

Preferably, the outlet holes 16 may be formed on the side member 13 by processing separate holes. Also preferably, a tooling hole molded for the insertion of a tool or a painting hole molded for the painting of the side member 13 may be used as at least one of the outlet holes 16.

Accordingly, the outlet duct of the battery system for the hybrid electric vehicle in accordance with the preferred embodiment of the present invention can provide an air discharge path in the order of the inlet duct→battery system→outlet duct→side member inlet hole→side member flow path→side member outlet hole→outside.

As can be seen from FIGS. 1 to 3, the outlet duct of the battery system 17 has a shape that does not extend to the extractor grill but extends to a slight extent from the battery system 17 directly downwardly, and thus the length of the outlet duct can be shortened. Moreover, since the holes are provided on the side member of the rear filler assembly to directly match the outlet duct, it is possible to reduce the pressure resistance against the air flow in advance, thus improving the cooling performance.

Furthermore, as shown in FIG. 4, since the tooling hole or the painting hole conventionally used in manufacturing the vehicle can be used as a discharge outlet through which air is discharged to the outside, the discharge portion of the outlet duct can be placed at the bottom, and thus it is possible to prevent water or dust from being introduced from the bottom of the vehicle.

As described above, the outlet duct applied to the battery system for the hybrid electric vehicle in accordance with the preferred embodiment of the present invention provides advantages. For example, the pressure resistance against the air flow is reduced by shortening the length of the outlet duct, thereby smoothing air flow smooth and reducing fluid loss. Moreover, since the existing tooling hole or painting hole can be used as the outlet hole for discharging the air to the outside, the air can be smoothly discharged to the outside during the operation of the vehicle. Furthermore, since the length of the outlet duct is shortened compared with the conventional one, it is possible to decrease the number of processes and reduce the working time, thus significantly improving the productivity. Also, since the number of parts of the outlet duct is decreased, the outlet route is simplified, the size occupying the trunk space is reduced, and available space is increased. Additionally, since the number of parts is decreased and the length of the outlet duct is shortened, manufacturing cost is reduced.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An outlet duct of a battery system for a hybrid electric vehicle, the battery system including an inlet duct for the inflow of indoor air, a blower, and an outlet duct for discharging air after cooling process, wherein the outlet duct is connected to a side member of a rear filler assembly provided with at least one inlet hole, through which air is introduced from the outlet duct, formed at a front end thereof and at least one outlet hole, through which air is discharged to an outside, formed at a rear end thereof, and the inner space of the side member is used as a flow path of air.

2. The outlet duct of claim 1, wherein a tooling hole or a painting hole formed on the side member is used as the outlet hole of the side member.

3. The outlet duct of claim 1, wherein the outlet hole of the side member is provided on a bottom surface of the side member so that air is discharged downwardly.

4. The outlet duct of claim 3, wherein a tooling hole or a painting hole formed on the side member is used as the outlet hole of the side member.

5. The outlet duct of claim 1, wherein the side member is provided with one inlet hole and two outlet holes.

6. The outlet duct of claim 5, wherein a tooling hole or a painting hole formed on the side member is used as at least one of the two outlet holes of the side member.
